(19) United States
(12) Patent Application Publication
(10) Pub. No.: US 2022/0137248 A1
(43) Pub. Date: May 5, 2022

(54) COMPUTING PROGRAM PRODUCT AND METHOD FOR PROSPECTING AND ELIMINATING SURFACE-RELATED MULTIPLES IN THE BEAM DOMAIN WITH DEGHOST OPERATOR

(71) Applicants: China Petroleum & Chemical Corporation, Beijing (CN); Sinopec Tech Houston, Houston, TX (US)

(72) Inventor: Xiang Xiao, Houston, TX (US)

(21) Appl. No.: 17/087,037

(22) Filed: Nov. 2, 2020

(51) Int. Cl. G01V 1/36; G06F 17/11; G06T 5/00; G01V 1/30

(52) U.S. Cl. CPC G01V 1/36; G01V 1/30; G06T 5/002; G06F 17/11

(57) ABSTRACT

A computing program product and method for prospecting and eliminating surface-related multiples in the beam domain with deghost operator, are disclosed. The method and system are based on the compress-sensing theory, which decompose the common shot data into sparse shot beams, then convolve the sparse beams instead of dense traces, to construct the surface related multiples. Those constructed multiples can be either subtracted from the data domain or the image domain, and surface-related-multiple-free images, can thereafter be generated to help illuminate and interpret the targets.

### TECHNICAL FIELD

The present disclosure relates generally to computer-implemented methods and systems, used to prospect or eliminate surface reflections during seismic exploration and processing in the beam-domain, using compressed-sensing methodologies while employing a beam-domain deghost operator.

### BACKGROUND OF INVENTION

### 1. Overview

Seismic exploration, also called seismic survey, involves the study of subsurface formations of interest and geological structures. In general, the purpose of seismic exploration is to image the subsurface of a survey region to identify potential locations of hydrocarbon underneath the surface.

In seismic exploration, one or more sources of seismic energy are placed at various locations near the surface of the earth to generate a signal in the form of waves, which travel downward through the earth while entering subsurface formations, like rocks, and caves. Once the waves generated as a result of the emitted seismic energy, enter the subsurface formation, they get reflected, refracted, or scattered throughout the subsurface, which are then captured by a receiving sensor that records, samples or measures said waves. The recorded waves are commonly referred to in the art, as seismic data or seismic traces. These data or traces may contain information regarding the geological structure and properties of the survey region being explored. They are then analyzed to extract details of the structure and properties of the survey region of the earth being explored.

Seismic prospecting it is the first stage of the geological analysis, and search for hydrocarbon within the subsurface. It has its basis in the classical physical principles of transmission, reflection, refraction, and scattering of elastic waves in a layered solid half-space. The great increase in application of the methods and the continual effort to improve them since 1925 have resulted in elaboration and refinement of instruments, methods, systems, and interpretation techniques. It is the most expensive method of geophysical prospecting, yet the most powerful as it can map beds many thousands of feet deep and detect depth variations of the order of a few feet. The basic procedure involves generating elastic waves by a near-surface-explosion, to record the resulting waves reaching the surface at various distances, and to deduce the positions of reflecting and refracting interfaces by analysis of the travel times and characteristics of identifiable wave groups. The techniques using refracted waves differ completely from those based on reflected waves. Some common geophysical prospecting techniques known in the art include:

a) Seismic method;

b) Gravity method;

c) Magnetic Method;

d) Electrical method;

e) Radioactive method;

f) Well logging method; and

g) Electromagnetic method.

Prospecting is based on the analysis of elastic waves generated in the earth by artificial means. The elastic waves produced during sudden disturbances, are often referred to as seismic waves. These seismic waves are recorded using an instrument like the seismograph, and the record obtained is the seismogram. As such, it is an important geophysical prospecting method, applied in the exploration of oil and gas deposits, deep ground water exploration, depth estimation or geotechnical problems. One skilled in the art will recognize, that seismic prospecting can be done by two methods: (a) the refraction; or (b) the reflection.

Refraction shooting method is useful only for mapping a bed in which the velocity is greater than in those above it. The shot to detector distance must be several times greater than the depth of the bed, since the refracted waves must travel a considerable horizontal distance through the bed on a minimum time path.

Reflection shooting methods uses near vertical reflections of compressional waves hence the shot to detector distance is small compared to the depth of the reflecting bed. The principal problem is to isolate the reflection from scattered waves and low velocity surface waves by filtering, mixing signals from large arrays of detectors, automatic control of gain, and advantageous arrangement of the explosive charges.

Seismic waves are further classified into the following:
1) Compressional, longitudinal, or primary waves (P-waves). These comprises of the motion of particles in a medium with direction towards the propagation of the wave. These waves have the highest velocity, can travel through any type of material, and are generally the first to be recorded. They are formed from alternating compression and expansion movements.
2) Shear, transverse, or secondary waves (S-waves). Occur when the motion of the particles in a medium is perpendicular to the direction of the propagation of the wave. As such, these waves can travel only through solids, as liquids or gases do not support shear stresses. Because of their direction, S-waves tend to move slower than P-waves.
3) Surface waves (L-waves). These waves are analogous to water waves, and travel along the earth's surface. They are typically categorized as either: (a) Rayleigh waves, or (b) Love waves. The former travels in the vertical plane, but with reference to the direction of propagation, and the motion is elliptical. In love waves, the motion of the particle is horizontal and transverses to the direction of propagation.

Nevertheless, most subsurface formations of interest or geological structures have developed fractures which were originated during karstification, and this karst system was then buried underground. Therefore, the main storage space for hydrocarbon has been in caves and the fractured zones along those caves which, in a sense, made that the key content of karst characterization, to be cave identification (Fei, Tan, Zhongxing, Wang, Fuqi, Cheng, Wei, Xin, Olalekan, Fayemi, Wang, Zhang, and Xiaocai, Shan; 3-Dimensional Geophysical Characterization of Deeply Buried Paleokarst System in the Tahe Oilfield, Tarim Basin, China; MDPI, Basel, Switzerland; Received: 19 Apr. 2019; Accepted: 16 May 2019; Published: 20 May 2019). As this has not been an easy task, a combination approach of core sample description, well logging interpretation, and 3D seismic modeling and high-resolution impedance dataset was originally proposed by Fei Tian, supra, to delineate the 3D geometry of the paleo-caves and other paleo-karst oil fields.

### 2. Analysis of Waves

It is known by persons of ordinary skill in the art, that depth-domain seismic images from the reverse-time-migration (RTM) model, reveals the reflectivity from the subsurface interfaces with impedance contrasts; and angle gathers contain information about the amplitude variation with angle (AVA). It is also known that fractured-cave systems with different scale and size, are common features in carbonate fractured reservoirs. These systems contribute a lot to the production of oil and gas, because they provide both storage spaces and migration pathways for hydrocarbons. Using seismic data, like prestack gathers and post-stack seismic attributes to identify the characteristics of the fractured-cave system, is a key approach to better understand the carbonate pathway of fractured reservoirs. As such, several methods have been proposed.

The coherence algorithm (Marfurt, Kurt & Scheet, Ronald & Sharp, John & Harper, Mark, (1998), Suppress of the acquisition footprint for seismic sequence attribute mapping, Geophysics, vol. 63, 10.1190/1.1444380.), the variance algorithm (P. Van Bemmel, R. Pepper, Seismic signal processing method and apparatus for generating a cube of variance values, U.S. Pat. No. 6,151,555, Issued on No. 21, 2000), and the curvature algorithm (Al-Dossary, Saleh & Marfurt, Kurt, (2006), 3D volumetric multispectral estimates of reflector curvature and rotation, Geophysics, vol. 71, 10.1190/1.2242449) to just name a few, are popular methods in the art, used to characterize the physical properties of fractures using post-stack seismic attributes. On 7the other hand, the amplitude versus azimuth inversion for velocity anisotropy (Rüger A. and Tsvankin I., 1997, Using AVO for fracture detection: analytic basis and practical solutions Leading Edge, vol. 10, pp. 1429-34), and for attenuation azimuth anisotropy (Shekar, Bharath & Tsvankin, Ilya, (2012), Attenuation analysis for heterogeneous transversely isotropic media, pp. 1-6, 10.1190/segam2012-1489.1), also both using pre-stack seismic azimuth gathers are implemented to characterize the fractured reservoir parameters.

On the other hand, hydrocarbon predictions from seismic amplitude and amplitude-versus-offset (“AVO”) still remain a difficult task. An approach is to use seismic reflections to closely relate them to subsurface rock properties. Yet, the strongest AVO in the seismic data is often caused by hydrocarbon saturation in the rocks. Advances on the use of prestack seismic inversion for extracting information in terms of subsurface elastic parameters for seismic data have tremendously helped in characterizing lithofacies and predicting reservoir properties with minimum error thereby reducing the number of dry wells and drilling risks in some basins of the world (See e.g. Russel, B., 2014, Prestack seismic amplitude analysis: an integrated overview: Interpretation, v.2, no. 2, SC19-SC36). Such prestack seismic inversion models have been routinely applied for lithology prediction and fluid detection to identify potential targets for oil and gas exploration. Most recently, it has been widely used for estimating sweet spots in unconventional shale gas applications yet, in the presence of multiples, this becomes a challenging task because the introduced errors and artifacts will significantly harm the migration, reflection tomography and velocity estimation process.

### 3. The application of Surface Related Multiple Elimination (SRME)

A surface-related multiple, is a downward reflection at the surface of the survey region after it has started propagating from its source or point of incidence. These reflections are recorded at by receiver or receiving sensor at a receiver point location, due to a shot or point of incidence at certain location over a survey region. As such, individuals skill in the art, readily see that this surface-related multiple event can be considered as the composition of two events: (a) one recorded at a first surface reflection due to a shot at certain point of incidence, and (b) a second one recorded at a different location, after the first surface reflection occurred. Both of these events are recorded independently on land or sea and occurred by either a ground explosion or the movement of a ship from left to right. When the position of the first surface reflection has been observed by a receiving sensor (i.e. where a downward reflection of the surface multiple that has taken place is known), the multiple can be predicted by convolving the individual events which were recorded already. But of course, here the challenge exist before the receiving sensor is able to find the position of the first surface reflection, for which known computer-implement methods in the art, perform convolutions of individual events for all possible locations typically assuming, or estimating second surface reflection. As such, for a given source-receiver pair, all possible combinations of ray paths are made, and the total travel time of every event is calculated. According to Fermat's principle, the multiple for that source-receiver pair then become the event which has the least travel time. Thus, the basic operation in SRME is a spatial-temporal convolution of the data with itself. This gives the correct kinematics of the surface related multiples, while estimating multiple models and adaptively subtracted from the input data. Nevertheless, a person of ordinary skill in the art will soon realize that elimination of free-surface multiples from seismic reflection data is an essential pre-processing step in seismic imaging. Yet, due to the high velocity contrasts at either the earth, or the water bottom, first layer multiples tend to decay slowly and degrade the quality of a large part of the seismogram severely. In addition, peg legs are generated off structurally complex 3D sedimentary bodies to create a complicated set of reverberations that can easily obscure primary reflections from relatively weak sedimentary reflectors.

Typical surface-related multiple elimination is applied in three steps (Verschuur, D. J., and Berkhout, A. J., 1997, Estimation of multiple scattering by iterative inversion, Part II: Practical aspects and examples, Geophysics vol. 62, 1596-1611; and Berkhout, A. J., 1982, Seismic Migration, Imaging of acoustic energy by wavefield extrapolation, vol. 14A: Theoretical aspects, Elsevier, Amsterdam). The first step includes the preprocessing of any acquired data such as image gathers, by removing of all non-physical noise; then regularizing the acquired data to obtain a constant grid of source and receiver locations; followed by an interpolation of missing near offsets and missing intermediate offsets; and then the removal of the direct wave and its surface reflection. Since the method is data-driven, the quality of the data after multiple removals, depends heavily upon this pre-processed step, hence why individuals skill in the art have developed a myriad of pre-processing alternatives that also take into consideration the characteristics survey region.

The second step involves the prediction or estimation of multiples, based on the observation that any surface-related multiple can be predicted through temporal and spatial convolutions of the measured wavefield with itself (Berkhout, A. J., supra.).

In the last step, individuals skilled in the art subtract or eliminate the predicted multiples from the image gathers data, using the minimum energy criterion, which states that, after the subtraction of the multiples, the total energy in the seismogram should be minimized.

Nonetheless and for a long time, the SRME method has been considered to be promising, but too expensive and too difficult to run in production, requiring extensive computational processing power. However, due to both increased computer performance and increased understanding of the crucial data preparation steps, the industry seems to be moving towards a broader application of the method, and it has even replaced more conventional methods in some onboard processing projects. Yet, current acquisition configurations prohibit the application of 3D SRME.

### 4. Source-Based and Receiver-Based Deghosting

The source and receiver ghost effects during survey (either on land or marine exploration) acquisition are deterministic spatial deconvolutions (See Amundsen, L., L. T. Ikelle, and L. E. Berg, 2001, Multi-dimensional signature deconvolution and free-surface multiple elimination of marine multicomponent ocean-bottom seismic data, Geophysics, vol. 66, pp. 1594-1604), generally cause angle-dependent notches in the spectrum and severe attenuation of the low frequencies.

In the case of standard seismic acquisition, deghosting is a challenging preprocessing step, which is the reason why it was generally excluded. However, nowadays there is a renewed interest in receiver-side ghost suppression because it removes the large sidelobes of the seismic wavelet and therefore, improves the image resolution significantly mainly by executing a double deconvolution step on a direct and a mirror migration result. Other deghosting methods have also been introduced which include: (a) bootstrapping method based on the generation of mirror data with a 1D ray-tracing approximation (See Wang, P., and C. Peng, 2012, Premigration deghosting for marine towed streamer data using a bootstrap approach; 82nd Annual International Meeting, SEG, Expanded Abstracts, vol. 31, pp. 1-5); (b) estimating the vertical particle-motion component from marine pressure data by convolving the result of a sparse deconvolution of the pressure ghost wavelet with the corresponding ghost wavelet of the particle motion, and then performing a conventional deghosting technique based on combining pressure data with particle velocity data (See Ferber, R., P. Caprioli, and L. West, 2013, L1 pseudo-vz estimation and deghosting of single-component marine towed streamer data, Geophysics, vol. 78, no. 2, pp. WA21-WA26,; (c) using the fact that the upward waves arrive earlier than the downward ‘ghost’ waves, leading to causal deghosting filters to shift the ghost events out of the time window (See Beasley, C. J., R. Coates, Y. Ji, and J. Perdomo, 2013, Wave equation receiver deghosting: a provocative example: 83rd Annual International Meeting, SEG, Expanded Abstracts, 32, 4226-4230; Ferber, R., and C. J. Beasley, 2014, Simulating ultra-deep-tow marine seismic data for receiver Deghosting, 76th Annual International Conference and Exhibition, EAGE, Extended Abstracts; and Robertsson, J. O. A., L. Amundsen, and O. Pedersen, 2014, Deghosting of arbitrarily depth-varying marine hydrophone streamer data by time-space domain modelling, 84th Annual International Meeting, SEG, Expanded Abstracts, pp. 4248-4252).

Deghosting is sensitive to errors in the ghost model, resulting from an array of uncertainties in the survey model, receiver location, surface and subsurface reflections. In most cases during exploration, either the land or sea surface can be dense or rough which can make the sea-surface reflection coefficient very frequency-dependent, therefore not exactly known. Other uncertainties when using ghost models belong to receiver depth measured during acquisition, temperature, and subsurface composition which are temporally and spatially varying between receiver and the surface.

As such, these affects the velocity data gathers, thereby influencing the wave propagation which results in ringing in the deghosted data. At the receiver side Rickett et al. (2014) developed an adaptive deghosting algorithm that takes into account small deviations in these parameters.

### 5. 5D Regularization & Interpolation

Oil and gas companies require dense 3D seismic geometric data to enhance subsurface images, particularly in the case of complex subsurface structures and complicated stratigraphy. However, in the 1990s, most acquisitions were not dense which caused irregularly spaced sampled data to be transformed into regular sampled data to avoid seismic data processing problems. 5D regularization and interpolation (inline, crossline, offset class x, offset class y, and frequency domain) assists in the determination of parameters for the pre-processing and velocity analysis.

Notably, interpolation performs two valuable roles. Firstly, it allows holes to be filled, fully or partially depending on their extent. The gaps are often related to acquisition layout or issues. Secondly it allows a person having ordinary skills in the art to increase spatial sampling density which has beneficial implications for aliasing and stack fold.

Regularization on the other hand, places the seismic data onto a regular grid, which helps when merging multiple surveys and can be beneficial or even vital for subsequent migration.

Data is typically regularized using Fourier's theory and through implementing estimation methods that locate frequency on an irregular grid (See Xu, S., Zhang, Y., Pham, D., 2005, Anti-Leakage Fourier Transform for seismic data regularization. Regularization, vol. 70, pp. V78-V95.). After the estimation of Fourier coefficients, data can be reconstructed on any grid. As Fourier regularization aims to fill gaps in seismic data, its density increase makes it adequate for constructing common offset vectors (COVs). The bin size of the geometry is determined by the spacing of the receivers and shots on lines that define the cross-spread (See Poole, G., Trad, D., Wombell, R., Williams, G., 2009, Regularisation for Wide Azimuth Datasets, InEAGE Workshop on Marine Seismic-Focus on Middle East and North Africa.). Data that are regularized in the shots and receivers improve the signal-to-noise ratio, coherency, and the alignment of reflection events (See S. Chopra, K. J. Marfurt, (2013), Preconditioning seismic data with 5D interpolation for computing geometric attributes Leading Edge, vol. 32, pp. 1456-1460).

Regularization and interpolation can be applied to many different domains; for example, if there are missing receivers, data interpolation is applied on the shot gather, and vice versa (Vermeer, G. J., 2002, 3-D seismic survey design. Society of Exploration Geophysicists). In complex geology, 5D regularization and interpolation techniques provide significant improvements, allowing seismic data inputs to be densely sampled on a regular grid without spatial aliasing in such directions such as IL, XL and COV (Xu, S., Zhang, Y., Lambaré, G., 2010, Antileakage Fourier transform for seismic data regularization in higher dimensions, Geophysics, Vol. 75(6)).

Therefore, the application of 5D regularization and interpolation to seismic imaging helps to reduce the migration smiles that result from bad geometry layout and can cause gaps in seismic data. This process is also effective for shallow structures, subsurface imaging of complex geology, and the NA of ground rolls and guided waves. In addition, it enhances the energy sampling and improves CMP gathers and mini CVS for velocity analysis. 5D regularization and interpolation provides high resolution in flat structures.

However, 5D regularization and interpolation is an extremely sensitive process and, as such, the domain and sorting of the data will lead to different results. This is particularly true for complex geological cases, where it may affect both the amplitude and nature of geological fractures.

### 6. Conclusion

As observed from the above background, most skilled in the art usually use a simple SRME flow in time domain with certain preprocessing (e.g., de-signature and deghost), which is in fact the traditional (time-domain) SRME method, that instead is slow and less accurate. This traditional SRME method treats the source and receiver depth/ghost effects at the convolution point as secondary errors in the prediction stage and does not take appropriate steps to remove it. Instead, the traditional SRME method, adopts a least-square matching filter (Verschuur, supra) or curvelet method to compensate the ghost effects at the convolution point together with source wavelet effects.

The conventional surface-related multiple elimination method of Verschuur, supra, in the data domain, often require notorious high computation resources and are much more expensive than the following seismic processing including tomography and (reverse-time/Kirchhoff) migrations. Those drawbacks are often encountered when individuals skilled in the art have terabytes of dense data in a standard Rich-Azimuth/Wide-Azimuth marine or land survey. In fact, the traditional SRME method treats the source and receiver depth/ghost effects at the convolution point as secondary errors in the prediction stage and does not take appropriate procedure to remove it. Instead, the traditional SRME method in production, adopts a least-square matching filter (Verschuur, supra) or curvelet method to compensate for the ghost effects at the convolution point together with source wavelet effects. Again, this traditional SRME method treats the data 3D sampling issues as the first-order factor instead and uses the 5D type regularization methods (or less accurate shot and cable interpolation/ extrapolations) to reduce the multiple prediction sampling errors. For current production 3D WAZ/FAZ SRME method, the common preprocessing steps include the source designature, 3D data-domain source- and receiver-side deghost, and the 5D regularization, etc.

On the other hand, beam-methods that are based on the compress-sensing theory, can decompose the dense data into sparse seismic elements and then save them for future seismic processing. The sparse beam elements are described by most important attributes including location, dips and wavelets, and capable of representing those complex /dense prestack dataset for following tomography and migration. By simplifying the seismic processing in the sparse beam domain, the time-consuming seismic processing can be greatly reduced to acceptable turnaround time.

Even with those obvious advantages, no applications of data-based beam processing in the beam domain are mentioned for the data-based, surface-related multiple or interbed multiple removal.

Thus, as a result of all the shortcomings of each of the individual technologies available in the art and that are sometimes used to fill the shortcomings of the traditional SRME method it is essential to employ multiple prediction and elimination methods that require no a priori information, either structural or material, about the subsurface geology, and which leave unaffected all relevant information present in the data. In fact, due to these shortcomings, it has become a skill in the art to provide mostly estimation of results instead of actual results; almost as trial and error testing, thereby making projects more costly and time consuming. Nevertheless, with the wider availability and access to computer program products embedded in high computational systems, these shortcomings can be avoided and large scientific and engineer problems like the foregoing be solved in a cost and time effective way. As such, the current invention improves addresses the speed and accuracy issue of traditional data-based time-domain SRME method.

### SUMMARY OF THE INVENTION

Typically, exploration and reservoir characterizations are performed over a region that is surveyed for its soil, and fluid potential properties. Depending upon the properties found in the survey region, one or various hydrocarbon reservoirs (i.e., oil and gas) may be revealed. Thereafter an accurate location and amplitude of the targeted hydro carbonate from the prestack seismic data can be acquired at the earth surface. Nonetheless, in presence of the multiples, this becomes a challenging task because the introduced errors and artifacts will significantly harm the migration, reflection tomography and velocity estimation process. As such, the present invention overcomes the existing shortcomings of prior art by providing a novel and improved computer program product that can prevent crosstalk between ghosts or between primaries, while at the same time generating more accurate predictions for multiples thereby making the subtraction process easier, faster, and less computational intensive.

The present invention is implemented on both CPU and GPU hardware for either regular or irregular beam forming, but instead of going trace-by-trace which is a slow, and computational intensive operation as it requires multiple tables saved into a local/global memory resource, it uses beam domain SRME with a novel deghost operator that eliminates bottlenecks from a computing system's I/O, and fully utilizes the computation power of cluster CPUs and GPUs, thereby making the SRME operation much faster, and efficient when comparing it with depth Kirchhoff/RTM modules.

In one embodiment of the present invention, the pre-processing steps include the source designature or deconvoluting 3D data-domain source and receiver-side deghost, and the 5D regularization. Furthermore, the present invention does not require that the data-domain deghost and designature to be a crucial step as the 5D regularization or 5D interpolations steps (e.g., source and cable interpolation/extrapolation, near/zero offset interpolation /extrapolation), and therefore can be ignored. Nonetheless, embodiments of the present can also execute, through the computer program product, deconvolution imaging conditioning as well as migration-domain deghosting to minimize the ghost/source-wavelet effects on the fast-track products. Therefore, the additional beam-domain deghost operator added to the beam-domain SRME operating instructions of the present invention, demonstrate its superiority with some 2D/3D synthetic, and live production datasets.

For example, embodiments of the present inventions were applied to a Sigsbee 2.5D model (3D), SRME to the Pluto 2D elastic model (2D), BP2004 2D model (2D), Seam2D model (2D), Sigsbee 2D model (2D), with a data set having: (i) 41 sail lines; (ii) 178 shots per sail line; (iii) 178 cables each shot; (iv) 1068 channels each cable; (v) inline 450 ft shot interval; (vi) 75 ft receiver interval; (vii) source and receiver at 50 ft deep relative to the surface; (viii) 30 Hz max frequency; (ix) grid intervals of 75*75*25 ft; and (x) apertures at 24 km*24 km to the maximum model depth 9.1 km. The results of the application of these embodiments were a successful prediction of the primaries and surface-related multiples, while at the same time producing a migration image and gathers, showing that the surface-related multiples to have been effectively removed.

Nevertheless, further details, examples, and aspects of the invention will still be described below in more detail, also referring to the drawings listed in the present invention.

### BRIEF DESCRIPTION OF THE DRAWINGS

The teachings of the present invention can be readily understood by considering the following detailed description in conjunction with the accompanying drawings.

FIG. 1, is a schematic diagram showing a cross-sectional view of a survey region with a well location, source locations, receiver locations, and elements, according to an embodiment of the present disclosure;

FIG. 2, illustrates a flow chart of the method and instructions to be used in a computer program product embodied in a non-transitory computer readable device, that stores instructions for performing by a device a method that prospects and eliminates a surface-related multiple, in beam-domain, employing a beam-domain deghost operator, according to an embodiment of the present disclosure;

FIG. 3, illustrates a flow chart of the sub-routine of executing a computer program product for pre-processing the retrieved set of common image gathers; according to an embodiment of the present disclosure;

FIG. 4, illustrates a flow chart of the sub-routine of executing a computer program product for decomposing the retrieved set of common image gathers; according to an embodiment of the present disclosure;

FIG. 5, is an illustration showing the survey region in a 2D model domain as the computer program product is executing the method that prospects and eliminates a surface-related multiple, in beam-domain, employing a beam-domain deghost operator, according to an embodiment of the present disclosure; and

FIG. 6, is an electric diagram, in block form of the computing program product embodied, that stores instructions for implementation by a device a method that prospects and eliminates a surface-related multiple, in beam-domain, employing a beam-domain deghost operator, according to an embodiment of the present disclosure.

### DETAILED DESCRIPTION OF THE INVENTION

Reference will now be made in detail, to several embodiments of the present disclosures, examples of which, are illustrated in the accompanying figures. It is noted that wherever practicable similar or like reference symbols may be used in the figures and may indicate similar or like functionality. The figures depict embodiments of the present disclosure, for purposes of illustration only. One skilled in the art will readily recognize from the following description that alternative embodiments of the structures, systems, and methods illustrated therein may be employed without departing from the principles of the disclosure described herein.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a computer program product that stores instructions that once executed by a system result in the execution of the method.

Additionally, the flowcharts and block diagrams in the Figures (“FIG.”) illustrate the architecture, functionality, and operation of possible implementations of systems, methods, and computer program products according to various embodiments of the present disclosure. It should also be noted that, in some alternative implementations, the functions noted in the block may occur out of the order noted in the Figures. For examples, two blocks shown in succession may, in fact, be executed substantially concurrently, or the blocks may sometimes be executed in the reverse order, depending upon the functionality involved. It will also be noted that each block of the block diagrams and/or flowcharts illustration, and combinations of blocks in the block diagrams and/or flowchart illustration, can be implemented by special purpose hardware-based systems that perform the specified hardware functions or acts, or combinations of special purpose hardware and computer instructions.

Any reference in the specification to a computer program product should be applied mutatis mutandis to a system capable of executing the instructions stored in the computer program product and should be applied mutatis mutandis to method that may be executed by a system that reads the instructions stored in the non-transitory computer readable medium.

As used herein, “and/or” placed between a first entity and a second entity means one of (1) the first entity, (2) the second entity, and (3) the first entity and the second entity. Multiple elements listed with “and/or” should be construed in the same fashion, i.e., “one or more” of the elements so conjoined.

There may be provided a system, a computer program product and a method for dissipation of an electrical charge stored in a region of an object. The region of the object may be any part of the object. The region may have any shape and/or any size.

The object may be a part of the system. Alternatively, the object may be a substrate or any other item that may be reviewed by the system, inspected by the system and/or measured by the system.

As previously mentioned, exploration seismology aims at revealing the accurate location and amplitude of a target hydro carbonate within the subsurface from the prestack seismic data acquired at the earth surface. In presence of the multiples, this becomes a challenging task because the introduced errors and artifacts will significantly harm the migration, reflection tomography and velocity estimation process. To date, traditional or more advanced SRME method have treated the data with 3D sampling issues as the first-order factor instead and uses the 5D type regularization methods (or less accurate shot and cable interpolation/extrapolations) in order to reduce the multiple prediction sampling errors. Even with the obvious advantages of each of the existing SRME methods, few or none applications of data-based beam processing in the beam domain, have been mentioned in the art for the data-based, surface-related multiple or interbed multiple removal.

Therefore, embodiments of the present invention are based on the compress-sensing theory, wherein a beam method can decompose the dense data into sparse seismic elements and then save them for future seismic processing. The sparse beam elements are then described by their most relevant attributes including location, dips and wavelets, and capable of representing those complex and dense prestack dataset for following tomography and migration processing. Furthermore, embodiments of the present invention simplify the seismic processing in the sparse beam domain, which in turns reduces the time and computational-consuming seismic processing, to an acceptable turnaround time. Additionally, embodiments of the present invention introduce an additional beam-domain deghost operator into the beam-domain SRME flow, and thereby demonstrating its superiority over 2D/3D synthetic, and real datasets.

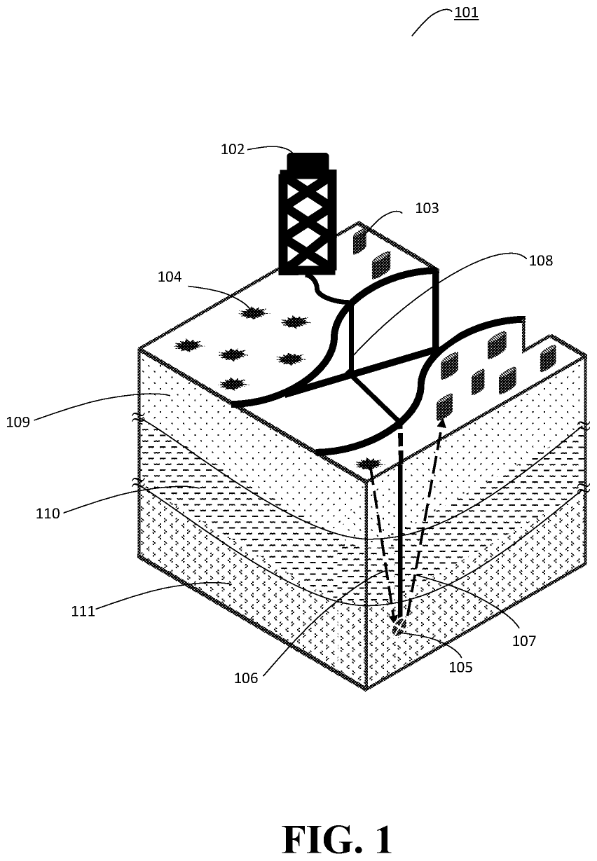

Turning over to FIG. 1, it represents a typical survey region 101, over a land-based region, showing different types of earth formation, 109, 110, 111, in which an embodiment of the present invention is useful. Persons of ordinary skill in the art, will recognize that seismic survey regions produce detailed images of local geology in order to determine the location and size of possible hydrocarbon (oil and gas) reservoirs, and therefore a well location 105. Nevertheless, as observed in FIG. 1, when using MWD downhole systems 108 during directional drilling, in order to reach the well or reservoir 105, the MWD downhole system 108 must deviate from a vertical downward trajectory, to a trajectory that is kept within prescribed limits of azimuth and inclination to reach a well or reservoir 105. This degree of deviation is given by a myriad of situations, but most likely due to populated or obstructed areas.

In these survey regions 101, sound waves bounce off underground rock formations during blasts at various points of incidence, sources, or shots 104, and the waves that reflect back to the surface are captured by seismic data recording or receiving sensors, 103, transmitted by data transmission systems 602, wirelessly, from said sensors, 103, then stored for later processing, and analysis by the computing program product, embodied in a non-transitory computer readable device, that stores instructions for performing by a device, a method that prospects and eliminates a surface-related multiple, in beam-domain, employing a beam-domain deghost operator.

In particular, persons having ordinary skill in the art will soon realize that the present example shows a common midpoint-style gather, wherein seismic data traces are sorted by surface geometry to approximate a single reflection point in the earth. In this example, data from several shots and receivers may be combined into a single image gather or used individually depending upon the type of analysis to be performed. Although the present example may illustrate a flat reflector and a respective image gather class, other types or classes of image gathers known in the art maybe used, and its selection may depend upon the presence of various earth conditions or events. As shown on FIG. 1, the reflections captured by the multiple seismic data recording sensors 103, each of which will be placed at different location offsets from each other, and the well 105. Because all points of incidences or shots 104, and all seismic data recording sensors 103 are placed at different offsets, the survey seismic data or traces, also known in the art as gathers, will be recorded at various angles of incidence represented by reflections to (downward transmission rays) 106 and from (upward transmission reflection) 107 the reservoir 105. Well location 105, in this example, is illustrated with an existing drilled well attached to a wellbore, 102, along which multiple measurements are obtained using techniques known in the art. This wellbore 102, is used to obtain well log data, that includes P-wave velocity, S-wave velocity, Density, among others. Other sensors, not depicted in FIG. 1, are placed within the survey region to also capture horizons data information required for interpreters and persons of ordinary skilled in the art to perform various geophysical analysis. In the present example, the gathers will be sorted from field records in order to examine the dependence of amplitude, signal-to -noise, move-out, frequency content, phase, and other seismic attributes, on incidence angles, offset measurements, azimuth, and other geometric attributes that are important for data processing and imaging and known by persons having ordinary skills in the art.

A receiving system or sensor as used herein, typically includes at least hardware capable of executing machine readable instructions, as well as the software for executing acts (typically machine-readable instructions) that produce a desired result. In addition, a retrieving system may include hybrids of hardware and software, as well as computer sub-systems.

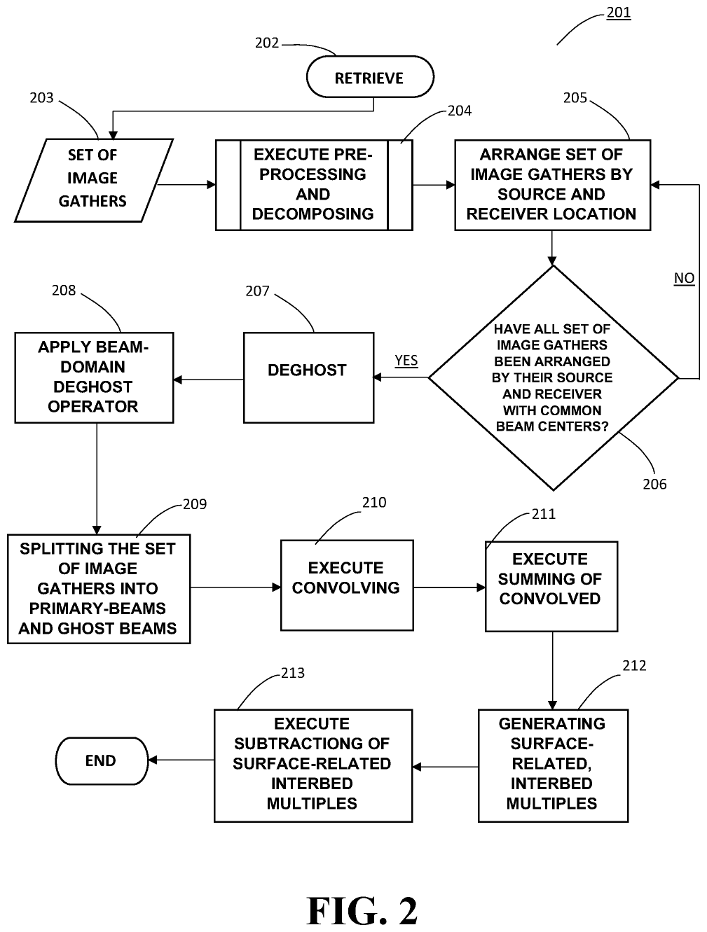

Turning over to FIG. 2, 201 illustrates a flow chart of the method and instructions to be used in a computer program product embodied in a non-transitory computer readable device, that stores instructions for performing by a device a method that prospects and eliminates a surface-related multiple, in beam-domain, employing a beam-domain deghost operator. The method and instructions to be used in a computer program product embodied in a non-transitory computer readable device, that stores instructions for performing by a device a method that prospects and eliminates a surface-related multiple, in beam-domain, employing a beam-domain deghost operator, 201, begins by retrieving at 202 certain information from a survey region 101. In particular, the method starts when the non-transitory computer readable device, 605, of the computing program product embodied in a computing system device 601, receives a message hook from the telemetry system 602 that it has started retrieving data at 202 from a plurality of receiver sensors 103 located over a defined survey region 101, containing a set of image gather 203 from the survey region. Nevertheless, a person having ordinary skills in the art, will soon realize that the retrieved data 203 may also be acquired in a variety of other ways, like from an external database already containing said data, from a variety of seismic surface or subsurface seismic tomography surveys, as well as from the memory resource 603, of the computing program product embodied in a computing system device 601.

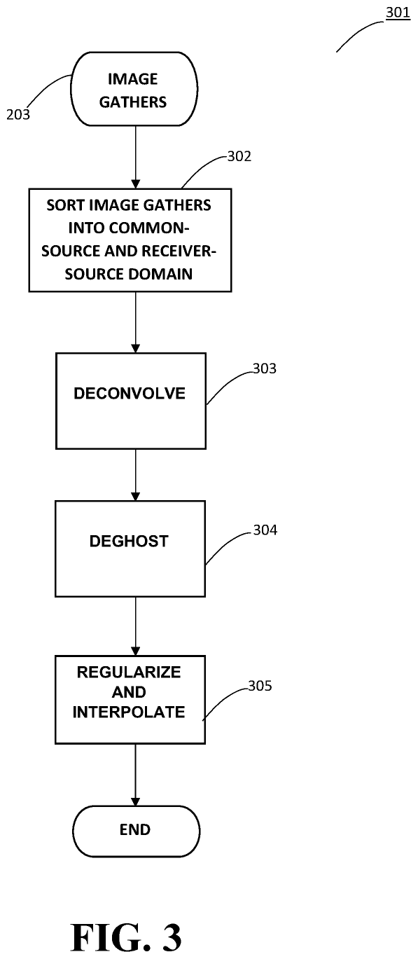

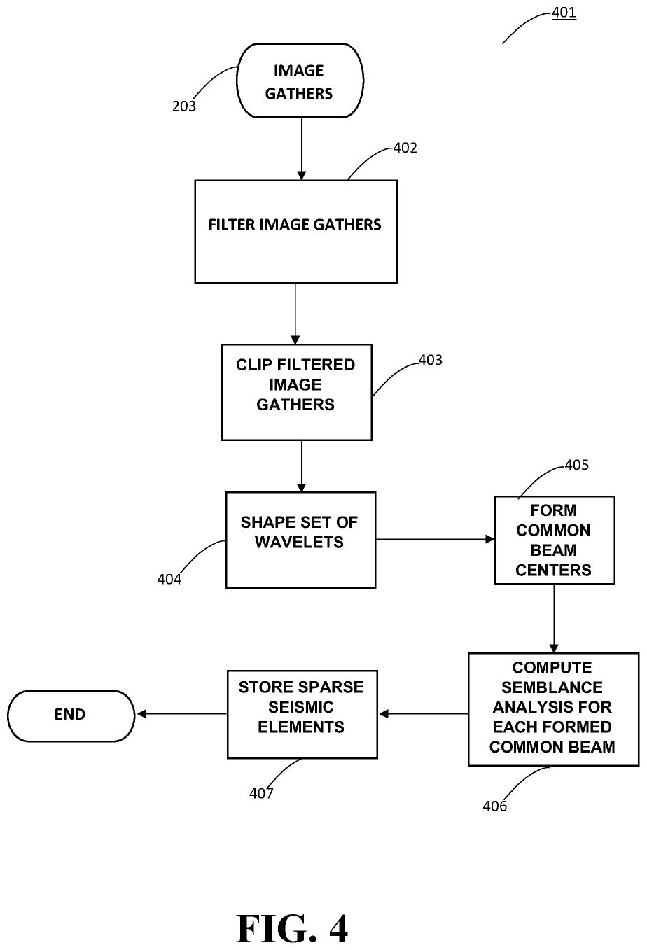

Once said set of image gathers 203 has been retrieved, the non-transitory computer readable device, 605 will message the memory resource 603, of the computing program product embodied in a computing system device 601, to begin executing at 204 a multi-thread two-part sub-routine, which is illustrated by FIG. 3 and FIG. 4. In particular, 301 illustrates how the sub-routine executes the computer program product for pre-processing the retrieved set of common image gathers. This is initiated by the non-transitory computer readable device, 605 executing a sorting command 302, over the set of image gathers into common shot/receiver gather and adapted to the input multiples by a least-square matching or curvelet matching method. Upon successfully executing the sorting command, the non-transitory computer readable device, 605 will begin deconvolving 303 in order to remove the embedded wavelets from the original input data (D_{X}_{_{g}}(L, g, p^{s}, τ)) 203, either in the data domain or the image domain. It is important to note, that even when the input data (Dₓ_{_{g}}(L, g, p^{s}, τ)) 203, is not preprocessed with source designature, or not preprocessed with source-side and receiver-side ghost removed in the 3D data-domain, the simple or traditional SRME flow in the time/beam domain would still be able to use a least-square matching filter or curvelet method to compensate the ghost effects at the convolution point together with source wavelet effects. Yet, those effects will create second-order errors when comparing to the 3D field data sampling issues which are not observed by the present invention due to the execution of step 204.

After the deconvolution has been executed by the non-transitory computer readable device, 605 it will begin the process 304 of conventional deghosting both sides (source and receiver) in order to prevent crosstalk between ghosts or between primaries while predicting the multiples by convolving the primaries with ghosts. Thereafter, the non-transitory computer readable device 605, will regularized using a combination of Fourier's theory and estimation methods to locate frequency on the irregular grid of the survey region 101 in order to obtain a constant grid of source and receiver locations. followed by an interpolation of missing near offsets and missing intermediate offsets.

Depending upon the computing program's utilization of the computing system device 601 the non-transitory computer readable device 605, will determine whether the subroutines within 204 will be performed in parallel or in sequence with a typical resource (CPU, GPU, and memory) utilization of less than 70%. Accordingly, the non-transitory computer readable device 605, will begin executing the computer program product for decomposing the retrieved set of common image gathers, having several common beam centers 401. This step begins with a structure-oriented filtering at 402, of the image gathers 203 in order to remove any undesired prestack seismic phenomena, while preserving amplitude of the 203 gathers. Said filtering 402 is not only executed along the offset, but also azimuth, inline, and crossline directions along the structural dip found in the survey region 101. Thereafter, the non-transitory computer readable device 605, will clip the filtered set of image gathers at 403 to the exact value of the image, in order to allow for more precision of the retrieved set of image gathers 203, as well as increase compatibility with other applications. One the set of image gathers 203, have been clipped the non-transitory computer readable device 605, will begin shaping wavelets at 404 from clipped gathers to form beams at 405. The wavelet shaping that occurs at 404 is a localized transform in both time and frequency domains and is advantageous to the method of the present invention as it is used to extract information from a signal that is not possible to unravel with a Fourier or even windowed Fourier transform. Additionally, beam forming step 405 will take the form of multi-arrival Kirchhoff-beam migration in order to make the image cleaner for post-processing. Once the beam is formed, the non-transitory computer readable device 605, will determine its composition in the form of a regular or irregular beam. If the beam is regularly formed, then the non-transitory computer readable device 605, will perform a Fast Fourier Transform (FFT), and the calculate the Inverse FFT. On the other hand, if the beam formed is irregular, then the non-transitory computer readable device 605, will execute the following algorithm:

$${D}_{{X}_{c}} ( X , {p}^{′} , ω ) = \vert \frac{ω}{{ω}_{x}} \vert \int \int \frac{{dx}^{′} {dy}^{′}}{4 {π}^{2}} {D}_{{X}_{c}} ( {r}^{′} , ω ) exp [ {iωp}^{′} \cdot ( {r}^{′} - X ) - \vert \frac{ω}{{ω}_{x}} \vert \frac{\vert {r}^{′} - X {\vert}^{2}}{2 {ω}_{x}^{2}} ] \qquad ( 1 )$$

Upon successfully forming the beams of step 405, the non-transitory computer readable device 605, will begin computing semblance 406, in order to further refine the land acquisition input data. The use of this technique along makes it possible to greatly increase the resolution of the data despite the presence of background noise. Furthermore, those skilled in the art will soon recognize that the new data received following the computation of semblance 406 will be easier to interpret when trying to deduce the underground structure of an area. Weighted semblance can also be used by the non-transitory program computer readable memory storage device, 605, upon selection by a user of the computer program product, using the computer system device 606, through either the keyboard 609 or the mouse 610. This will help increase the resolution of traditional semblance and thereby make the traditional semblance analysis capable of providing more complicated seismic data. In the present embodiment, the computation of semblance utilizes the following algorithm:

$${D}_{{X}_{c}} ( X , {p}^{′} , ω ) = \vert \frac{ω}{{ω}_{x}} \vert \int \int \frac{{dx}^{′} {dy}^{′}}{4 {π}^{2}} {D}_{{X}_{c}} ( {r}^{′} , ω ) {e}^{[ {iωp}^{′} \cdot ( {r}^{′} - X ) - \vert \frac{ω}{{ω}_{x}} \vert \frac{\vert {r}^{′} - X {\vert}^{2}}{2 {ω}_{x}^{2}} ]} ; \qquad ( 2 )$$

Once the semblance has been computed at 406, the non-transitory program computer readable memory storage device 603, signals the computer system device 606, to display on monitor 608 the shot and receiver events, as well as each wavelet. The person having ordinary skills in the art, operating the computer system device 606, will soon realize from observing the display monitor 608, which events and wavelets are relevant from each semblance, and select them by using a combination of keyboard 609 and mouse 609 from the computer system device 606. Upon selection, the person of ordinary skills operating the computer system device 606, will be presented with a graphical user interface in monitor 608 asking to confirm selection. If a selection is confirmed, then the computer system device 606 messages the non-transitory program computer readable device, 603 via the communication bus 604, to store at 407, the sparse seismic elements which will typically include selected event(s) and wavelet(s) for each semblance. If the selection is not confirmed, the non-transitory program computer readable device 605, presents the events and wavelets through the computer system's 606 monitor 608 again for selection. Once the selected event(s) and wavelet(s) is/are stored at 407, the system exits sub-routine and finalizes the execution of the computer program product for pre-processing and decomposing the retrieved set of common image gathers, having several common beam centers, 204.

The memory resource 603, will send a signal over the communication bus 604, for the non-transitory computer readable device 605 to begin arranging or fixing at 205 the pre-processed and decomposed set of image gathers by their respective source and receiver location. The non-transitory computer readable device 605 will loop or repeat at 206 the processes of arranging until all set of image gather have been arranged by their source and receivers with common beam centers. Nonetheless, before moving on to the next step, the non-transitory computer readable device 605 will present someone skilled in the art operating the computer system device 606 through display monitor 608, with a graphical user interface to determine whether the non-transitory computer readable device 605 has satisfactorily completed step 206. Upon confirmation, the computer system device 606 messages the non-transitory program computer readable device, 603 via the communication bus 604, to begin deghosting at 207, the receiver-side/shot-side for common shot/receiver data, respectively.

At step 207, the non-transitory computer readable device, 605 will verify that all sub-routines executed at step 204 were successfully performed and begin deghosting at 207 applying the deghost operator to both sides (receiver and source) at 208. In particular, the beam-domain deghost that occurs at 207 for the source-side on decomposed common-shot Tau-P data D_{X}_{_{S}} (L, p^{g}, ω) (with source-side ghost already removed in the preprocessing step 204) will be implemented according to the following algorithm:

$${D}_{{X}_{s}}^{P} ( L , {p}^{g} , ω ) = \frac{{D}_{{X}_{s}} ( L , {p}^{g} , ω )}{( sin [ {z}_{g} ω \sqrt{\frac{1}{{v}^{2}} - {( {p}^{g} )}^{2}} ] )} \qquad ( 3 )$$

Where (3) has p^{s} and p^{g} as the initial source-receiver ray slowness vector of the beams respectively; zₛ and z_{g} as source-receiver depth respectively; and v as the velocity of the water column. D_{X}_{ₛ}^{P} (L, p^{g}, ω) is then the ghost-compensated primaries Tau-P data for common shot Xₛ, thereby (3) causing ghost side-lobes to collapse, whilst retaining the original phase of the wavelet. On the other hand, the beam-domain deghost for the receiver-side on a decomposed common-shot Tau-P data will be implemented according to the following algorithm equation that removes the receiver ghosts and retains the kinematics leaving a primary event at its actual arrival time:

$${D}_{{X}_{s}}^{P} ( L , {p}^{g} , ω ) = \frac{{D}_{{X}_{s}} ( L , {p}^{g} , ω )}{( exp [ 2 {iz}_{g} ω \sqrt{\frac{1}{{v}^{2}} - {( {p}^{g} )}^{2}} ] - 1 )} \qquad ( 4 )$$

As such, these beam-domain deg hosting algorithms executed at 207 by the non-transitory computer readable device, 605 are more accurate than a traditional data-domain 3D deghost as they are not performed as an inversion and computationally less-intensive and faster. These algorithms (3) and (4) take into account the source and receiver depth/ghost effects at the convolution point away from the free sea surface, so it can prevent cross-talks between ghosts or cross-talks between primaries, while predicting the multiples by convolving the beam primaries with beam ghosts. After algorithms (3) and (4) are executed, the decomposed common-shot Tau-P data D_{X}_{ₛ} (L, p^{g}, ω) is then split into beam primaries D_{X}_{ₛ} (L, p^{g}, ω) and beam ghosts D_{X}_{ₛ}^{G} (L, ₚ^{g}, ω) at 209 by the non-transitory computer readable device, 605.

With the beams split into primaries and ghost, the non-transitory computer readable device, 605 begins executing the steps of convolving and then summing the beam ghosts with beam primaries, at 210 and 211 respectively. Once the beam ghosts and the beam primaries have been summed together by the non-transitory computer readable device, 605, it generates at 212 the predicted surface-related/interbed multiples for common shot using algorithm (5) and algorithm (6) for the receiver data.

$$\begin{matrix}m ( s , {s}^{′} = {g}^{′} , t ) = {\sum }_{L , p , τ} \{ {D}_{{X}_{s}}^{P} ( L , s , {p}^{g} , τ ) * {D}_{{X}_{{s}^{′}}}^{G} ( L , {s}^{′} , - {p}^{g} , t - τ ) + {D}_{{X}_{s}}^{G} ( L , s , {p}^{g} , τ ) * {D}_{{X}_{{s}^{′}}}^{P} ( L , {s}^{′} , - {p}^{g} , t - τ ) \} & ( 5 ) \\ m ( g , {g}^{′} = {s}^{′} , t ) = {\sum }_{L , p , τ} \{ {D}_{{X}_{g}}^{P} ( L , g , {p}^{s} , τ ) * {D}_{{X}_{{g}^{′}}}^{G} ( L , {g}^{′} , - {p}^{s} , t - τ ) + {D}_{{X}_{g}}^{G} ( L , g , {p}^{s} , τ ) * {D}_{{X}_{{g}^{′}}}^{P} ( L , {g}^{′} , - {p}^{s} , t - τ ) \} & ( 6 )\end{matrix}$$

7Where from the above algorithms, m(s, g′, t) is one predicted multiple trace with source at s and receiver at g′, or m(g, s′,t) is the predicted multiple at source s′ and receiver g. Then the predicted multiple trace m(s, g′, t) or are sorted into common shot/receiver gather, and adapted to the input multiples by a least-square matching or curvelet matching method, finally it will be subtracted and removed from the original input data either in the data domain or the image domain. Note that for algorithm (5), if the source-side ghost is not removed in the 3D data-domain deghost preprocessing, the beam domain source-side deghost can also be implemented in the common receiver beam migration stage on predict primary data d_{X}_{ₛ}(s, g′, t)-m(s, g′, t) which can be sorted into common-receiver domain. Nonetheless, these prediction multiples in algorithm (5) and (6), take into account the source and receiver depth/ghost effects at the convolution point away from the free sea surface, so it can prevent cross-talk between ghosts or between primaries while predicting the multiples by convolving the primaries with ghosts.

Thereafter, and after the non-transitory computer readable device 605, has generated the surface-related interbed multiples, it being executing at 213 the subtraction of the surface-related/interbed multiples in the data domain or in the image domain using least-square subtraction or curvelet subtraction. This will trigger, the non-transitory computer readable device 605 to signal the memory resource 603 to begin storing the added and eliminated a surface-related interbed multiples, in beam-domain, employing a beam-domain deghost operator. Furthermore, the non-transitory computer readable device 605 will signal the computer system device 606, to display on 608 a message to the user of the computing program product embodied in a computing system device 601, to decide whether to also store said generated the added and eliminated a surface-related interbed multiples, in beam-domain, employing a beam-domain deghost operator, to a different memory resource memory resource, such as an external memory device, to print the results to the printing device 611, or both.

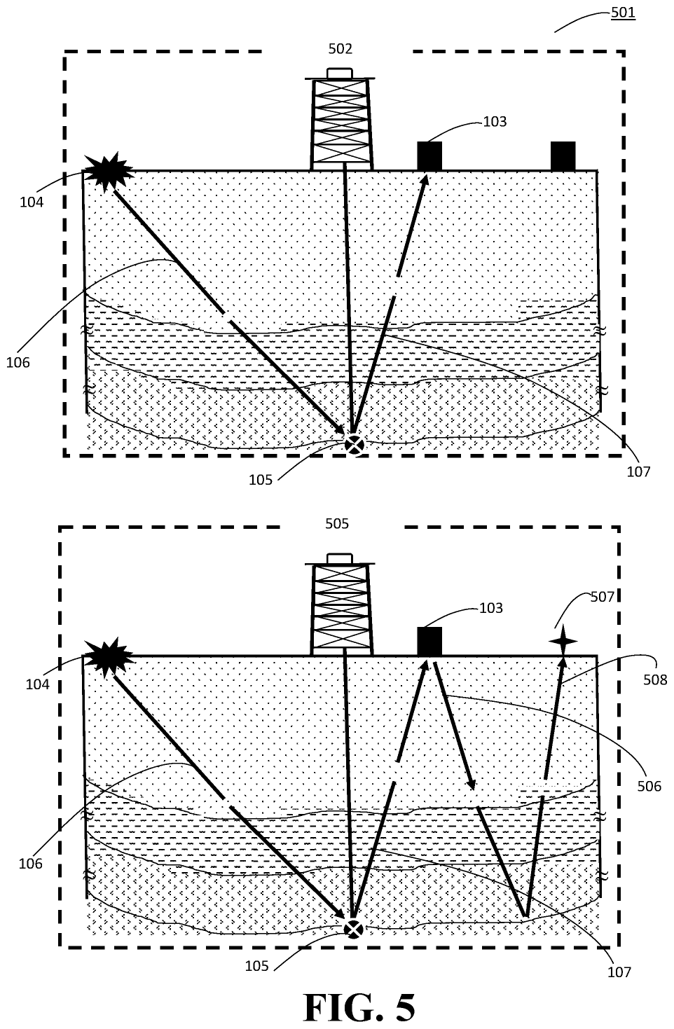

FIG. 5, is an illustration showing the survey region 101, as a result of performing the array of operations and instructions for performing the method that prospects and eliminates a surface-related multiple, in beam-domain, employing a beam-domain deghost operator, 201 of FIG. 2. In particular, to achieve said results, FIG. 5 is shown divided by a primary beam represented by 502 and a ghost beam represented by 505. To sort them out and produce a useful outcome that can be utilized in the field by those skilled in the art, embodiments of the present disclosure process algorithms within method 201 represented by FIG. 2.

As it is shown on 502, the primary beam is represented by the input common shot data at a source point of incidence or shot, s represented by 104 and receiver at g, represented by 103 after it has been preprocessed with source-side deghost by a data domain 3D deghost algorithm. At 502, source s 104 produces a downward beam 106, which reflects off reservoir 105, while receiver g captures its upward reflection represented by 107. These are then decomposed in the common shot domain [D_{X}_{ₛ}(r′, ω)], into common shot into Tau-P-domain sparse beams according to expression:

$${D}_{{X}_{s}} ( L , {p}^{g} , ω ) = \vert \frac{ω}{{ω}_{x}} \vert \int \int \frac{{dx}^{′} {dy}^{′}}{4 {π}^{2}} {D}_{{X}_{s}} ( {r}^{′} , ω ) exp [ iω {p}^{g} \cdot ( {r}^{′} - L ) - \vert \frac{ω}{{ω}_{x}} \vert \frac{\vert {r}^{′} - L {\vert}^{2}}{2 {ω}_{x}^{2}} ] ; \qquad ( 7 )$$

These, are then stacked according to expression:

I_{X}_{ₛ} (r)=−C₀Σₓ ∫dω∫∫dpₓ^{g}dp_{y}^{g}Uₓ(r; L, p; ω)* D_{X}_{ₛ}(L, p^{g}, ω) (8);

Here the function D_{X}_{ₛ}(L, p^{g}, ω) is the decomposed Tau-P data from common shot data (with source-side ghost already removed in the preprocessing), L is the common shot beam center L(Lₓ, L_{y}), p^{g} is the slowness vector (pₓ^{g}, p_{y}^{g}) at the receiver point r′(gₓ, g_{y}), r′ is the trace location r′ (gₓ, g_{y}), r is the image point r(x, y, z); D_{X}_{ₛ}(r′, ω) is the recorded wavefield at common shot Xₛ; Uₓ(r; L, p; ω) is the migration operator which expand as:

$${U}_{X} ( r ; L , p ; ω ) = \frac{- i ω}{2 π} \int \int \frac{d {p}_{y}^{r} d {p}_{x}^{r}}{{p}_{z}^{s}} {u}_{G B}^{*} ( r ; s , {p}^{s} ; ω ) * {u}_{G B}^{*} ( r ; g , {p}^{g} ; ω ) ; \qquad ( 9 )$$

Here u*_{GB}(r; s, p^{s}; ω) and u*_{GB}(r; g, p^{g}; ω) are the source beams and receiver beams respectively which can then be split into ghost beams 505, by the receiver-side beam domain deghost operator represented by 506. The computing program product 201, then executes the convolution instructions from the method that prospects and eliminates a surface-related multiple, in beam-domain, employing a beam-domain deghost operator; which convolves the top ghost beams (source at s represented by 104 and receiver at g represented by 103) with the bottom primary beams (source at s′ represented by 507 and receiver at g represented by 104) at the same convolution receiver point g, 103, that will generate a predict multiple beam with beam path s to g and g to s′, thereby forming a ghost*primary, wherein g, 103, actually becomes the beam center L. Thereafter the computing program product 201, will executes the summation instruction from the method that prospects and eliminates a surface-related multiple, in beam-domain, employing a beam-domain deghost operator; to the top predict beam (with beam path s to g to s′ and a form of ghost*primary) with another predict beam path from s to g to s′, as represented by beams 106, 107, 506, and 508 thereby forming a primary*ghost. The computing program product 201 will then sum over the convolution receiver point g/L with the slowness p to generate one predict surface-related multiple trace m(s,s′) with source at s and receiver at s′.

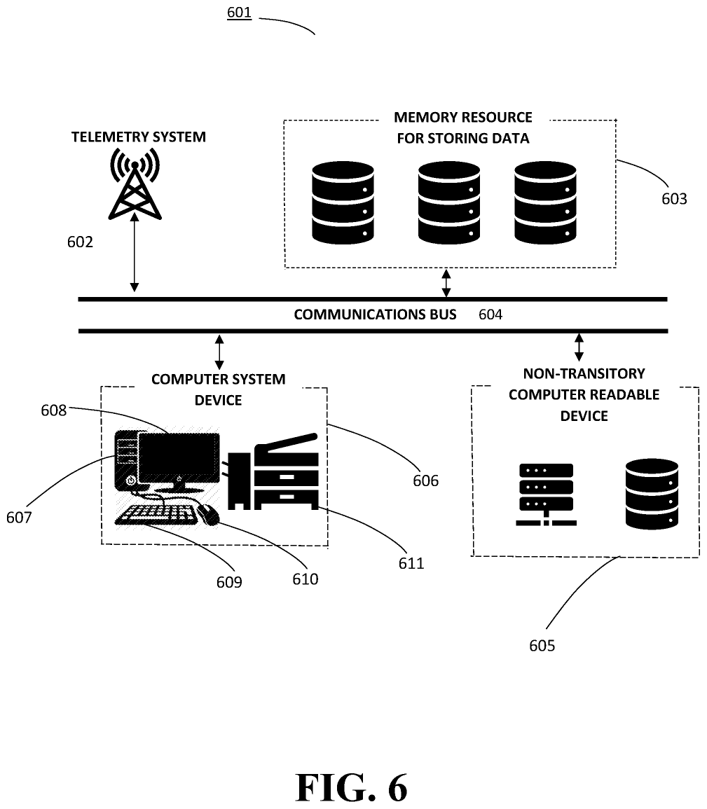

As it pertains to FIG. 6, the computing program product embodied in a computing system device 601 is shown comprising a telemetry system 602, a memory resource for storing data 603, a communication bus 604, a non-transitory computer readable device 605, and a computer system device 606. The computing program product embodied in a computing system device 601, illustrates a functional block diagram used to perform an array of operations and instruction for performing by a device, a method that prospects and eliminates a surface-related multiple, in beam-domain, employing a beam-domain deghost operator, 201 of FIG. 2.

The memory resource 603 may include any of various forms of memory media and memory access devices. For example, memory devices 603 may include semiconductor RAM and ROM devices as well as mass storage devices such as CD-ROM drives, magnetic disk drives, and magnetic tape drives.

The computer system device, 606, acts as a user interface the non-transitory program computer readable device, 605; to input, set, select, and perform the operations of acquiring, storing, splitting, computing, generating, retrieving, superimposing, re-sizing, locating, indexing, modelling, calculating, and repeating, (collectively the message hook procedures). Said computer system device, 606, is connected to (wired and/or wirelessly) through a communication device 604 to the telemetry system 602, to the memory resource 603, and to the non-transitory computer readable device 605. The computer system device, 606, further includes other devices like a central processing unit (CPU), 607, a display or monitor, 608, a keyboard, 609, a mouse, 610, and a printer, 611. One or more users may supply input to the computing program product embodied in a computing system device 601 through the set of input devices of the computing system 606 like 609 or 610. Nevertheless, a person having ordinary skills in the art will soon realize that input devices may also include devices such as digitizing pads, track balls, light pens, data gloves, eye orientation sensors, head orientation sensors, etc. The set of display devices 608 and 611 may also include devices such as projectors, head-mounted displays, plotters, etc.

In one embodiment of computing program product embodied in a computing system device 601 may include one or more communication devices (communications bus) 604, like network interface cards for interfacing with a computer network. For example, seismic data gathered at a remote site may be transmitted to the computing program product embodied in a computing system device 601 using a telemetry system 602, through a computer network. The computing program product embodied in a computing system device 601 may receive seismic data, coordinates, elements, source and receiver information from an external computer network using the communication's bus 604 network interface card. In other embodiments, the computing program product embodied in a computing system device 601 may include a plurality of computers and/or other components coupled over a computer network, where storage and/or computation implementing embodiments of the present may be distributed over the computers (and/or components) as desired.

The computing program product embodied in a computing system device, 601, has firmware, a kernel and a software providing for the connection and interoperability of the multiple connected devices, like the telemetry system 602, the memory resources for storing data, 603, the communication bus 604, the non-transitory computer readable device, 605, and the computer system device, 606. The computing program product embodied in a computing system device, 601, includes an operating system, a set of message hook procedures, and a system application.

Furthermore, because performance and computation costs are always an important issue, the computing program product embodied in a computing system device, 601, uses the non-transitory computer readable device, 605 to ensure that the steps of the method 201 will not be bottlenecked by the computing system (601) I/O, or any other network communications. In fact, file-distribution systems like Apache Hadoop in combination with proper data-compressions, as well as smart file caching according to the data will ensure that the operations or instructions performed by the computer program product for performing by a device, a method that prospects and eliminates a surface-related multiple, in beam-domain, employing a beam-domain deghost operator, 201, as shown on of FIG. 2; are only limited by the memory/cache speed and CPU/GPU computing power, and nothing else.

The operating system embedded within the computing program product embodied in a computing system device 601, may be a Microsoft “WINDOWS” operating system, OS/2 from IBM Corporation, UNIX, LINUX, Sun Microsystems, or Apple operating systems, as well as myriad embedded application operating systems, such as are available from Wind River, Inc.

The message hook procedures of computing program product embodied in a computing system device 601 may, for example, represent an operation or command of the memory resources, 603, the computer system device, 606, the non-transitory computer readable device, 605, which may be currently executing a certain step process or subroutine from the method that prospects and eliminates a surface-related multiple, in beam-domain, employing a beam-domain deghost operator, 201, as shown on of FIG. 2.

The set of message hook procedures may be first initiated by: (i) an input from a user, which will typically be a person having ordinary skills in the art, like the entering of user-defined values or parameters; (ii) the manipulation of the computer system device, 606; (iii) the processing of operations in the non-transitory computer readable memory device, 605; or (iv) automatically once certain data has been stored or retrieved by either the memory resources, 603, or the non-transitory computer readable memory device, 605. Based on any of these inputs, processes or manipulation events, the memory resource, 603, the non-transitory computer readable memory device, 605, or the computer system device, 606; generate a data packet that is passed using the communication bus, 604, which are indicative of the event that has occurred as well as the event that needs to occur. When either the memory resource, 603, the non-transitory computer readable device, 605, or the computer system device, 606, receive the data packet, they convert it into a message based on the event, and executes the required operations or instruction of 201. This is achieved when the operating system examines the message hook list and determines if any message hook procedures have registered themselves with the operating system before. If at least one message hook procedure has registered itself with the operating system, the operating system passes the message via the communication bus 604 to the registered message hook procedure that appears first on the list. The called message hook executes and returns a value to either the memory resource, 603, the non-transitory computer readable memory device, 605, or the computer system device, 606, instructing them, to pass the message to the next registered message hook, and either the memory resource, 603, the non-transitory computer readable memory device, 605, or the computer system device, 606. The computing program product embodied in a computing system device 601, continues executing the operations until all registered message hooks have passed, which indicates the completion of the operations or instruction 201, by the generation and storing a final generated surface-related, interbed multiples in data and images domain with subtracted multiples from the executed computer program product, to the memory resource, 603.

The non-transitory computer readable device, 605, is configured to read and execute program instructions, e.g., program instructions provided on a memory medium such as a set of one or more CD-ROMs and loaded into semiconductor memory at execution time. The non-transitory computer readable device, 605 may be coupled wired or wireless to memory resource 603 through the communication bus 604 (or through a collection of busses). In response to the program instructions, the non-transitory computer readable memory device, 605 may operate on data stored in one or more memory resource 603. The non-transitory computer readable memory device, 605 may include one or more programmable processors (e.g., microprocessors).

A “computer program product or computing system device” includes the direct act that causes generating, as well as any indirect act that facilitates generation. Indirect acts include providing software to a user, maintaining a website through which a user is enabled to affect a display, hyperlinking to such a website, or cooperating or partnering with an entity who performs such direct or indirect acts. Thus, a user may operate alone or in cooperation with a third-party vendor to enable the reference signal to be generated on a display device. A display device may be included as an output device, and shall be suitable for displaying the required information, such as without limitation a CRT monitor, an LCD monitor, a plasma device, a flat panel device, or printer. The display device may include a device which has been calibrated through the use of any conventional software intended to be used in evaluating, correcting, and/or improving display results (e.g., a color monitor that has been adjusted using monitor calibration software). Rather than (or in addition to) displaying the reference image on a display device, a method, consistent with the invention, may include providing a reference image to a subject.

Software includes any machine code stored in any memory medium, such as RAM or ROM, and machine code stored on other devices (such as non-transitory computer readable media like external hard drives, or flash memory, for example). Software may include source or object code, encompassing any set of instructions capable of being executed in a client machine, server machine, remote desktop, or terminal.

Combinations of software and hardware could also be used for providing enhanced functionality and performance for certain embodiments of the disclosed invention. One example is to directly manufacture software functions into a silicon chip. Accordingly, it should be understood that combinations of hardware and software are also included within the definition of a retrieving system and are thus envisioned by the invention as possible equivalent structures and equivalent methods.

Data structures are defined organizations of data that may enable an embodiment of the invention. For example, a data structure may provide an organization of data, or an organization of executable code. Data signals could be carried across non-transitory transmission mediums and stored and transported across various data structures, and, thus, may be used to transport an embodiment of the invention.

According to the preferred embodiment of the present invention, certain hardware, and software descriptions were detailed, merely as example embodiments and are not to limit the structure of implementation of the disclosed embodiments. For example, although many internal, and external components have been described, those with ordinary skills in the art will appreciate that such components and their interconnection are well known. Additionally, certain aspects of the disclosed invention may be embodied in software that is executed using one or more, receiving systems, computers systems devices, or non-transitory computer readable memory devices. Program aspects of the technology may be thought of as “products” or “articles of manufacture” typically in the form of executable code and/or associated data that is carried on, or embodied in, a type of machine readable medium. Tangible non-transitory “storage” type media and devices include any or all memory or other storage for the computers, process or the like, or associated modules thereof such as various semiconductor memories, tape drives, disk drives, optical or magnetic disks, and the like which may provide storage at any time for the software programming.

It is to be noted that, as used herein the term “survey region” refers to an area or volume of geologic interest, and may be associated with the geometry, attitude and arrangement of the area or volume at any measurement scale. A region may have characteristics such as folding, faulting, cooling, unloading, and/or fracturing that has occurred therein.

Also, the term “executing” encompasses a wide variety of actions, including calculating, determining, processing, deriving, investigation, look ups (e.g. looking up in a table, a database or another data structure), ascertaining and the like. It may also include receiving (e.g. receiving information), accessing (e.g. accessing data in a memory) and the like. “Executing” may include computing, resolving, selecting, choosing, establishing, and the like.

Acquiring certain data may include creating or distributing the referenced data to the subject by physical, telephonic, or electronic delivery, providing access over a network to the referenced data, or creating or distributing software to the subject configured to run on the subject's workstation or computer including the reference image. In one example, acquiring of a referenced data or information could involve enabling the subject to obtain the referenced data or information in hard copy form via a printer. For example, information, software, and/or instructions could be transmitted (e.g., electronically or physically via a data storage device or hard copy) and/or otherwise made available (e.g., via a network) in order to facilitate the subject using a printer to print a hard copy form of reference image. In such an example, the printer may be a printer which has been calibrated through the use of any conventional software intended to be used in evaluating, correcting, and/or improving printing results (e.g., a color printer that has been adjusted using color correction software).

Furthermore, modules, features, attributes, methodologies, and other aspects can be implemented as software, hardware, firmware or any combination thereof. Wherever a component of the invention is implemented as software, the component can be implemented as a standalone program, as part of a larger program, as a plurality of separate programs, as a statically or dynamically linked library, as a kernel loadable module, as a device driver, and/or in every and any other way known now or in the future to those of skill in the art of computer programming. Additionally, the invention is not limited to implementation in any specific operating system or environment.

While in the foregoing specification this disclosure has been described in relation to certain preferred embodiments thereof, and many details have been set forth for purpose of illustration, the invention is not to be unduly limited to the foregoing which has been set forth for illustrative purposes. On the contrary, a wide variety of modifications and alternative embodiments will be apparent to a person skilled in the art, without departing from the true scope of the invention, as defined in the claims set forth below. Additionally, it should be appreciated that structural features or method steps shown or described in any one embodiment herein can be used in other embodiments as well.

Symbols Table

| Symbol | Brief Definition | Symbol | Brief Definition |
|---|---|---|---|
| D_{X}_{_{c}} (X, p′, ω) | Frequency domain | D_{X}_{ₛ}^{P} (L, p^{g}, ω) | Primary beams for |
| | decomposed Tau-P | | frequency domain |
| | data from common | | decomposed Tau-P data |
| | spread X_{c} data, at Beam | | from common shot Xₛ |
| | center X and slowness | | data, at Beam center L |
| | p′ | | and receiver slowness |
| | | | p^{g} |
| x | Arbitrary point location | τ | Intercept time in tau-p |
| | | | domain |
| t | Time | g and g′ | Receiver location |
| ω | Harmonic waves of | D_{X}_{_{s′}}^{G} | Ghost beams for |
| | frequency | | frequency domain |
| | | | decomposed Tau-P data |
| | | | from common shot X_{s′} |
| | | | data |
| D_{X}_{_{c}} (r', ω) | Recorded frequency | m(g, g′ = s′, t) | Time domain multiple |
| | domain common spread | | trace with source at g′ = |
| | X_{c} wavefield at r′ | | s′ and receiver at g |
| α | P-wave velocity | p^{s} | Slowness vector at |
| | | | source s |
| T | Travel Time | D_{X}_{_{g}}^{P} and D_{X}_{_{g′}}^{P} | Primary beams for |
| | | | frequency domain |
| | | | decomposed Tau-P data |
| | | | from common receiver |
| | | | X_{g} and X_{g′} |
| ν and ν' | Velocity | I_{X}_{ₛ} (r) | Common shot Xₛ |
| | | | migration image at image |
| | | | point r |
| x | Location | | |
| z_{g} | Receiver depth | pₓ^{g} | x component of slowness |
| | | | vector p^{g} at receiver |
| | | | location g |
| X | Common spread beam | p_{y}^{g} | y component of slowness |
| | center | | vector p^{g} at receiver |
| | | | location g |
| p′ | Slowness vector | U_{X} | Common spread |
| | | | migration operator |
| r′ | Trace location | p^{g} | Slowness vector at |
| | | | receiver g location |
| X_{c} | Common Spread point | p_{z}^{s} | z component of slowness |
| | | | vector p^{s} at source |
| | | | location s |
| D_{X}_{_{c}} (X, p′, ω) | Frequency domain | D_{X}_{ₛ}^{P} (L, p^{g} , ω) | Primary beams for |
| | decomposed Tau-P | | frequency domain |
| | data from common | | decomposed Tau-P data |
| | spread X_{c} data, at Beam | | from common shot Xₛ |
| | center X and slowness | | data, at Beam center L |
| | p′ | | and receiver slowness |
| | | | p^{g} |
| x | Arbitrary point location | τ | Intercept time in tau-p |
| | | | domain |
| t | Time | g and g′ | Receiver location |
| ω | Harmonic waves of | D_{X}_{_{s′}}^{G} | Ghost beams for |
| | frequency | | frequency domain |
| | | | decomposed Tau-P data |
| | | | from common shot X_{s′} |
| | | | data |
| D_{X}_{_{c}} (r′, ω) | Recorded frequency | m(g, g′ = s′, t) | Time domain multiple |
| | domain common spread | | trace with source at g′ = |
| | X_{c} wavefield at r′ | | s′ and receiver at g |
| α | P-wave velocity | p^{s} | Slowness vector at |
| | | | source s |
| T | Travel Time | D_{X}_{_{g}}^{P} and D_{X}_{_{g′}}^{P} | Primary beams for |
| | | | frequency domain |
| | | | decomposed Tau-P data |
| | | | from common receiver |
| | | | X_{g} and X_{g′} |
| ν and ν′ | Velocity | I_{X}_{ₛ} (r) | Common shot Xₛ |
| | | | migration image at image |
| | | | point r |
| x | Location | | |

What is claimed is:

1. A computing program product, embodied in a computing system device with a non-transitory computer readable device, that stores instructions for performing by a device, a method that prospects and eliminates a surface-related multiple, in beam-domain, employing a beam-domain deghost operator. The instructions comprising:
retrieving a set of image gathers, preconditioned to preserve signal amplitude information at various angles of source and receiver points of incidence locations, having several common beam centers, over a survey region;
executing a computer program product for pre-processing the retrieved set of common image gathers, having several common beam centers, over a survey region;
executing a computer program product for decomposing the retrieved set of common image gathers, having several common beam centers, over a survey region;
arranging the pre-processed and decomposed set of image gathers by their source and receiver points of incidence locations with common beam centers, over a survey region over the survey region;
repeating the arranging step for each common beam center of the pre-processed and decomposed set of common image gathers;
deghosting the arranged common beam centers of each source and receiver points of incidence location;
applying a beam-domain deghost operator to the deghosted common beam centers at each source point of incidence location;
applying a beam-domain deghost operator to the deghosted of common beam centers at each receiver point of incidence location;
splitting the set of image gathers at all source points of incidence locations, with the applied beam-domain deghost operator into primary-beams and ghost beams over each common beam center;
splitting the set of image gathers at all receiver points of incidence locations, with the applied beam-domain deghost operator into primary-beams and ghost beams over each common beam center;
executing a computer program product for convolving the set of image gathers at all source and receiver points of incidence locations having the applied beam-domain deghost operator;
executing a computer program product for summing the convolved set of image gathers at all source and receiver points of incidence locations;
generating surface-related, interbed multiples in data and image domains, for each summed set of image gathers at all receiver points of incidence locations;
executing a computer program product for subtracting the generated surface-related, interbed multiples in data and images domain employing a least-square subtraction or curvelet subtraction; and
storing a final generated surface-related, interbed multiples in data and images domain with subtracted multiples from the executed computer program product, to a memory resource.

2. The computer program product of claim 1, wherein the non-transitory computer readable device further stores a computer program comprising program code instructions which can be loaded in a programmable device to cause said programmable device to implement the instructions according to claim 1, when said program is executed by a processor of said device, coupled through a communication bus to a memory resource.

3. The computing program product, embodied in a non-transitory computer readable device of claim 1, wherein the instruction of executing a computer program product for pre-processing the retrieved set of common image gathers further comprises:
a) sorting the retrieved set of image gathers, into common-source domain gathers and common-receiver domain gathers;
b) deconvolving the common-source domain gather and common-receiver domain gathers;
c) deghosting the deconvolved common-source domain gather and common-receiver domain gathers; and
d) regularizing and interpolating the deghosted common-source domain gather and common-receiver domain gathers.

4. The computing program product, embodied in a non-transitory computer readable device of claim 1, wherein the instruction of executing a computer program product for decomposing the retrieved set of common image gathers further comprises:
a) filtering the retrieved a set of image gathers;
b) clipping the filtered set of image gathers;
c) shaping a set of wavelets from the clipped image gathers;
d) forming common beam centers, over the survey region;
e) computing semblance analysis for each formed common beam centers, over the survey region; and
f) storing sparse seismic elements from the computed semblance analysis to a memory resource.

5. The computing program product, embodied in a non-transitory computer readable device of claim 1, wherein the instruction of applying a beam-domain deghost operator to the deghosted common beam centers at each source point of incidence location further comprises the expression:
$${D}_{{X}_{g}}^{P} ( L , {p}^{s} , ω ) = \frac{{D}_{{X}_{g}} ( L , {p}^{s} , ω )}{( exp [ 2 {iz}_{s} ω \sqrt{\frac{1}{{v}^{2}} - {( {p}^{s} )}^{2}} ] - 1 )}$$

6. The computing program product, embodied in a non-transitory computer readable device of claim 1, wherein the instruction of applying a beam-domain deghost operator to the deghosted of common beam centers at each receiver point of incidence location further comprises the expression:
$${D}_{{X}_{g}}^{P} ( L , {p}^{g} , ω ) = \frac{{D}_{{X}_{g}} ( L , {p}^{g} , ω )}{( exp [ 2 {iz}_{s} ω \sqrt{\frac{1}{{v}^{2}} - {( {p}^{s} )}^{2}} ] - 1 )}$$

7. The computing program product, embodied in a non-transitory computer readable device of claim 1, wherein the instruction of executing a computer program product for convolving the set of image gathers at all source points of incidence locations having the applied beam-domain deghost operator; further comprises the expression:
$$m ( s , {s}^{′} = {g}^{′} , t ) = {\sum }_{L , p , τ} \{ {D}_{{X}_{s}}^{P} ( L , s , {p}^{g} , τ ) * {D}_{{X}_{{s}^{′}}}^{G} ( L , {s}^{′} , - {p}^{g} , t - τ ) + {D}_{{X}_{s}}^{G} ( L , s , {p}^{g} , τ ) * {D}_{{X}_{{s}^{′}}}^{P} ( L , {s}^{′} , - {p}^{g} , t - τ ) \}$$

8. The computing program product, embodied in a non-transitory computer readable device of claim 1, wherein the instruction of executing a computer program product for convolving the set of image gathers at all receiver points of incidence locations having the applied beam-domain deghost operator; further comprises the expression:
$$m ( g , {g}^{′} = {s}^{′} , t ) = {\sum }_{L , p , τ} \{ {D}_{{X}_{g}}^{P} ( L , g , {p}^{s} , τ ) * {D}_{{X}_{{g}^{′}}}^{G} ( L , {g}^{′} , - {p}^{s} , t - τ ) + {D}_{{X}_{g}}^{G} ( L , g , {p}^{s} , τ ) * {D}_{{X}_{{g}^{′}}}^{P} ( L , {g}^{′} , - {p}^{s} , t - τ ) \}$$
